(19) United States
(12) Patent Application Publication
(10) Pub. No.: US 2009/0253813 A1
(43) Pub. Date: Oct. 8, 2009

(54) Colloidal silica consisting of silica particles fixing nitrogen contained alkaline compound

(76) Inventors: Yuko Ishiguri, Tokyo (JP); Kunio Ohkubo, Tokyo (JP); Yukiyo Saito, Tokyo (JP); Masahiro Izumi, Tokyo (JP); Masaru Nakajo, Tokyo (JP); Kuniaki Maejima, Tokyo (JP); Hiroaki Tanaka, Ayase-shi (JP)

Correspondence Address: FLYNN THIEL BOUTELL & TANIS, P.C., 2026 RAMBLING ROAD, KALAMAZOO, MI, 49008-1631, US

(21) Appl. No.: 12/322,296

(22) Filed: Jan. 30, 2009

(30) Foreign Application Priority Data
Apr. 2, 2008 (JP) 2008-24371
Apr. 2, 2008 (JP) 2008-24372
Apr. 2, 2008 (JP) 2008-24373
Apr. 2, 2008 (JP) 2008-24376
Apr. 2, 2008 (JP) 2008-24417
Apr. 2, 2008 (JP) 2008-24418

(51) Int. Cl. B01F 17/54; B01F 3/12

(52) U.S. Cl. 516/79

(57) ABSTRACT

A colloidal silica comprising, silica particles inside of which or on the surface of which a nitrogen containing alkaline compound is fixed, wherein said silica particles are prepared by forming and growing colloid particles using the nitrogen containing alkaline compound. Said colloidal silica can be prepared by preparing active silicic acid aqueous solution contacting silicate alkali aqueous solution with cation exchange resin, adding the nitrogen containing alkaline compound and heating, and then growing up particles by build-up method.

### FIELD OF THE INVENTION

The present invention relates to a colloidal silica, which is useful for ink absorbable fillers used for printing paper, spreading conditioners, hydrophilic coating agents for surface of various materials, high intensity binders, further, high purity silica gels, materials for high purity ceramics, binders for catalyst, in particular, abrasives for electronic materials, and a method for preparation thereof.

### BACKGROUND OF THE INVENTION

Concerning a colloidal silica prepared by using alkali metal silicate (mainly sodium silicate) as a starting material, many methods to obtain a colloidal silica whose content of alkali metal is small are proposed. For example, in Patent Document 1, a method to obtain a colloidal silica, whose content of sodium is small, using active silicic acid aqueous solution of water glass method and tetraalkylammonium hydroxide is described. It is well known that sodium existing in inside of silica particles elutes gradually to liquid phase from conventional colloidal silica prepared using active silicic acid aqueous solution of water glass method and sodium hydroxide, even if sodium is removed by cation-exchange method. Accordingly, in Patent Document 2, following method is disclosed. That is, after sodium is removed from colloidal silica by cation-exchange method, add ammonia so as to alkalize the colloidal silica, treat by an autoclave at 98-150° C. and elute sodium that exists in inside of silica particles compulsorily to liquid phase, then remove sodium by cation-exchange method.

Further, many types of colloidal silica composed of nonspherical silica particles are proposed. In Patent Document 3, a stable silica sol dispersed in liquid medium, which is characterized that amorphous colloidal silica particles having elongated shape extending to only one plane with uniform thickness in range of 5 to 40 nm observed by an electron microscope, is mentioned. In Patent Document 4, silica sol composed of silica particle of elongated shape obtainable by a method characterized by adding metal compounds such as aluminum salt before, in the middle or after an adding process of silicic acid solution is described. In Patent Document 5, a colloidal silica composed of cocoon shape silica particles whose ratio of long axis/short axis is from 1.4 to 2.2 prepared by hydrolysis of alkoxysilane is mentioned. In Patent Document 6, a method for preparation of colloidal silica containing nonspherical silica particles by using hydrolysis solution of alkoxysilane instead of active silicic acid aqueous solution of water glass method and by using tetraalkylammonium hydroxide as an alkali, is disclosed.
Patent Document 1: JP2003-89786 publication
Patent Document 2: JP2004-189534 publication; claims
Patent Document 3: JPH1-317115 publication; claims
Patent Document 4: JPH4-187512 publication
Patent Document 5: JPH11-60232 publication; claims
Patent Document 6: JP2001-48520 publication, claims and Examples

Colloidal silica mentioned in Patent Document 1 is desirable from the view point of lower content of sodium, however, shape of particles is not considered at all. Colloidal silica prepared by following the preparation method in Patent Document 2 contains ammonia in inside of particles since the preparation method requires ammonia as an essential ingredient. Therefore, there are disadvantages such as limitation of uses, time-consuming preparation process, waste of energy, and so on.

In a preparation process of a colloidal silica mentioned in Patent Document 3, since there is a process to add water soluble calcium salt, magnesium salt or mixture thereof, these salts are remaining in a product as impurities and it has limited uses. In a preparation process of a colloidal silica mentioned in Patent Document 4, since there is a process to add water soluble aluminum salt, this salt is remaining in a product as impurities and it has limited uses. Colloidal silica mentioned in Patent Document 5 and Patent Document 6 are desirable because silica source is alkoxysilane and purity of the product is high, however, the colloidal silica has disadvantages at the view point of removal of by-produced alcohol and at the view point of price.

### DISCLOSER OF THE INVENTION

Therefore, the object of the present invention is to provide a colloidal silica containing nonspherical particles cluster whose content of alkali metal is low and can be prepare without using metal compound except silicon, and to provide a method for preparation thereof.

The inventors of the present invention have conducted eager study and have obtained new colloidal silica, and above mentioned object is dissolved.

In the compound mentioned as a nitrogen containing alkaline compound in the present invention, tetraalkylammonium hydroxide is not included.

The first invention of the present invention is a colloidal silica comprising, silica particles inside of which or on the surface of which a nitrogen containing alkaline compound is fixed, wherein said silica particles are prepared by forming and growing colloid particles using the nitrogen containing alkaline compound. As a nitrogen containing alkaline compound, at least one compound selected from the group consisting of ethylenediamine, diethylenediamine, imidazole, methylimidazole, piperidine, morpholine, arginine, and hydrazine can be mentioned. The adequate amount of the nitrogen containing alkaline compound in the colloidal silica is in the range from 3 to 120 molar ratio of silica/nitrogen containing alkaline compound.

The second invention of the present invention is a colloidal silica fixing a nitrogen containing alkaline compound, which forms nonspherical particles cluster. Ratio of long axis/short axis of silica particles measured by a transmission electric microscope is from 1.1 to 15 and average value of the ratio of long axis/short axis is from 1.2 to 6. And it is desirable that the average length of short axis of the colloidal silica is from 5 to 30 nm.

The third invention of the present invention is a colloidal silica containing a nitrogen containing alkaline compound, wherein content of silica is from 10 to 50 weight percent and content of alkali metal is 50 ppm or less to silica.

The fourth invention of the present invention is a method for preparation of colloidal silica comprising, preparing active silicic acid aqueous solution by contacting alkali silicate aqueous solution with cation exchange resin, adding a nitrogen containing alkaline compound to said active silicic acid aqueous solution so as to alkalize the solution and to form colloidal particles by heating, maintaining alkaline state under heating condition, and growing particles by adding active silicic acid aqueous solution and the nitrogen containing alkaline compound. If excess nitrogen containing alkaline compound is existing in liquid phase after formation process of colloidal silica, it is possible to grow particles by adding active silicic acid aqueous solution alone.

In the present invention, hereinafter, both silica particles inside of which a nitrogen containing alkaline compound is fixed and silica particles on the surface of which a nitrogen containing alkaline compound is fixed by coating a film mainly composed of silica containing a nitrogen containing alkaline compound are mentioned as “silica particles to which nitrogen containing alkaline compound is fixed.”

### EFFECT OF THE INVENTION

By present invention, a colloidal silica whose alkali metal content is low and containing nonspherical particles cluster, which is useful for ink absorbable fillers used for printing paper, spreading conditioners, hydrophilic coating agents for surface of various materials, high intensity binders, high purity silica gels, materials for high purity ceramics, binders for catalyst, in particular, and abrasives for electronic materials can be provided in lower price.

### BRIEF ILLUSTRATION OF DRAWINGS

FIG. 1 is TEM observation picture of colloidal silica obtained in Example 1

FIG. 2 is TEM observation picture of colloidal silica obtained in Example 2

FIG. 3 is TEM observation picture of colloidal silica obtained in Example 3

FIG. 4 is TEM observation picture of colloidal silica obtained in Example 5

FIG. 5 is TEM observation picture of colloidal silica obtained in Example 6

FIG. 6 is TEM observation picture of colloidal silica obtained in Example 8

FIG. 7 is TEM observation picture of colloidal silica obtained in Example 10

FIG. 8 is TEM observation picture of colloidal silica obtained in Example 11

FIG. 9 is TEM observation picture of colloidal silica obtained in Example 12

FIG. 10 is TEM observation picture of colloidal silica obtained in Example 13

FIG. 11 is TEM observation picture of colloidal silica obtained in Example 14

FIG. 12 is TEM observation picture of colloidal silica obtained in Example 15

### DESCRIPTION OF PREFERRED EMBODIMENT

The present invention will be illustrated more in detail. Colloidal silica of the present invention is a colloidal silica obtained by using a nitrogen containing alkaline compound as an alkalizing agent at forming process and growing process of particles using active silicic acid. Accordingly, the nitrogen containing alkaline compound exists by three forms, that is, (1) fixed in inside of particles at growing process of particles, (2) fixed on the surface of particles after growth of particles, and (3) dissolved in liquid phase.

Further, since colloidal silica of the present invention uses nitrogen containing alkaline compound as an alkalizing agent, it forms nonspherical particles cluster characterizing that ratio of long axis/short axis measured by a transmission electric microscope of silica particles is from 1.1 to 15 and average value of said ratio of long axis/short axis is from 1.2 to 6.

The colloidal silica contains a nitrogen containing alkaline compound, and adequate range of the nitrogen containing alkaline compound is from 3 to 120 by molar ratio of silica/nitrogen containing alkaline compound. It is desirable to contain same nitrogen containing alkaline compound as used in growing process of colloidal particles. The nitrogen containing alkaline compound acts as an alkalizing agent to stabilize colloid, further has specific function in response to sorts of compound. For example, in a case when the colloidal silica is used as a binder of ceramics or catalysts, the colloidal silica is to be dried and to become a solid binder, and the nitrogen containing alkaline compound acts to protect growth of cracks by becoming dry. Further, when compared with a colloidal silica stabilized by alkali metal, the colloidal silica is superior in possibility to improve compatibility with organic solvent. Therefore, it is desirable to exist in above mentioned range. Unfixed nitrogen containing alkaline compound is dissolved in water phase, and is reduced in a concentration process with water in a ultrafiltration process. When molar ratio is smaller than above mentioned range, it is desirable to add and supplement after concentration.

However, existence of the nitrogen containing alkaline compound sometimes becomes harmful to environment. When such a case is considered, product from which the nitrogen containing alkaline compound is removed becomes necessary. A method to reduce nitrogen containing alkaline compound as much as possible using ultrafiltration effectively belongs to the category of preparation method of the present invention. In said case, it is desirable that molar ratio of silica/nitrogen containing alkaline compound does not exceed 120. When the ratio exceeds 120, stability of colloid deteriorates.

Compared with sodium hydroxide, logarithmic value of reciprocal number of acid dissociate constant (pKa) of acid dissociate constant at 25° C. is 6-12 and is smaller than that of sodium hydroxide, and is weak base. Therefore, it is necessary to use large amount of nitrogen containing alkaline compounds to make pH larger than 8. Accordingly, more desirably, molar ratio of silica/nitrogen containing alkaline compound is from 3 to 50.

By same reason, a method to use tetraalkylammonium hydroxide of quaternary ammonium hydroxide, which is strong base, together with nitrogen containing alkaline compound is also desirable. As tetraalkyl ammonium hydroxide, tetramethylammonium hydroxide, tetraethyl ammonium hydroxide, or trimethyl-2-hydroxyethylammonium hydroxide (other name is choline hydroxide) are desirable. By together use of quaternary ammonium hydroxide, which is strong base, growth of particles can be carried out in short time, and is a profitable preparation method.

Adequate molar ratio of silica/nitrogen containing alkaline compound by every nitrogen containing alkaline compounds are mentioned as follows. Range of molar ratio of silica/ethylenediamine is 20-120, and more desirably is 20-100.
Range of molar ratio of silica/diethylenediamine is 20-120, and more desirably is 20-70.
Range of molar ratio of silica/imidazole is 10-60, and more desirably is 10-50.
Range of molar ratio of silica/methylimidazole is 10-60, and more desirably is 10-50.
Range of molar ratio of silica/piperidine is 20-50, and more desirably is 20-30.
Range of molar ratio of silica/morpholine is 3-50, and more desirably is 5-40.
Range of molar ratio of silica/arginine is 10-120, and more desirably is 10-115.
Range of molar ratio of silica/hydrazine is 5-30, and more desirably is 5-25.

As mentioned above, necessary amount of piperidine, morpholine, and hydrazine are comparatively large, and is desirable to apply a method to use tetraalkylammonium hydroxide together with.

It is desirable that alkali metal content per silica is 50 ppm or less. In uses as a binder for ceramics or catalyst or as abrasives for electronic materials, it is necessary to set up the content of alkali metal to above mentioned level, and more desirable level is less than 30 ppm.

Colloidal silica forming nonspherical particles cluster is characterized to have bended rod shape and each particle of colloidal silica has individually different shape, and specifically is a colloidal silica containing silica particles having a shape shown in pictures of each Examples. Ratio of long axis/short axis of these colloidal silica are in the range from 1.1 to 15. Particles having closely spherical shape are partially existing, however, most of particles are of nonspherical shape. These are examples, and the shape of particles change variously according to preparation conditions, however, the majority is nonspherical shape particles.

Shape of silica particles of the colloidal silica of the present invention is similar to the shape of silica particles of fumed silica. Silica particles of fumed silica generally forms elongated particles cluster whose ratio of long axis/short axis is from 5 to 15. Primary particle size (sometimes, simply mentioned as particle size) of fumed silica indicates short axis (thickness) of primary particles and generally is between 7 to 40 nm. Further, the particles are flocculated and forming a secondary particles and the appearance of slurry is white. Therefore, it has disadvantages that particles are settled when the slurry is preserved for long time, and not form a transparent film or transparent coating film.

However, although silica particles of the present invention has a shape similar to that of primary particles of fumed silica, secondary particles are not formed and the appearance of slurry is transparent or semi-transparent. The silica particles of the present invention do not have a disadvantage that particles are settled, and can obtain a transparent film or transparent coating film.

A method for preparation of colloidal silica of the present invention is characterized as follows, that is, using active silicic acid aqueous solution of water glass method as a source of silica, obtained by using nitrogen containing alkaline compound as an alkalizing agent, further, not using alkali metal aqueous solution that is used in conventional method in growing process of colloid particles, but using the nitrogen containing alkaline compound.

This method for preparation of colloidal silica is roughly same as to a conventional method that uses alkali metal hydroxide or alkali silicate as an alkalizing agent. That is, a process to prepare activated sol sodium silicate is exactly same, and in a particles growing process, only a point that uses a nitrogen containing alkaline compound as an alkalizing agent is different, further, the process to obtain a product by concentration is same.

First of all, as alkali silicate aqueous solution, which is used as a starting material, sodium silicate aqueous solution, that is, generally called as water glass (water glass 1 to 4) is preferably used. This product is relatively cheap and can be purchased easily. And, in semiconductor field that dislike sodium ion, potassium silicate aqueous solution is suitable as a starting material. A method to prepare alkali silicate aqueous solution by dissolving solid alkali methasilicate in water can be also mentioned. Since alkali methasilicate is prepared through crystallizing process, sometimes lower impurity containing product can be obtained. Alkali silicate aqueous solution can be used by diluting with water in case of necessity.

As a cation exchange resin used in the present invention, well known products can be preferably used and not restricted. A contact process of alkali silicate aqueous solution with a cation exchange resin, for example, can be carried out by diluting alkali silicate aqueous solution to 1-10 weight percent silica concentration with water, then dealkalized by contacting with H type strong acidic cation exchange resin and deionized by contacting with OH type strong basic anion exchange resin at need. By said process, active silicic acid aqueous solution can be obtained. Regarding details of said contacting condition, various proposals are already proposed, and in the present invention, any well-known conditions can be used.

Secondary, growing process of colloid particles is carried out. In this growing process, alkali metal hydroxide that is used in conventional method is not used, and a nitrogen containing alkaline compound is used. In the growing process, tetramethylammonium hydroxide, tetraethyl ammonium hydroxide or choline hydroxide can be use together with the nitrogen containing alkaline compound. Since these quaternary ammonium are stronger base than the nitrogen containing alkaline compound, particle growing can be carried out in short time, accordingly can be said as an advantageous method.

In this growing process, operations of conventional method are carried out. For example, for the purpose to grow up colloid particles, a nitrogen containing alkaline compound is added so as the pH to become over 8, then heated at the temperature of 60-240° C., and particles whose size is 5-20 nm can be obtained. Further, a method of build-up is used. A method to add active silicic acid and a nitrogen containing alkaline compound to a species sol of 60-240° C. and pH of over 8, so as the pH to become 8-11. Thus, the particle size of silica can become 10-150 nm.

Then, the concentration of silica is carried out, and a concentration by ultrafiltration is used. Concentration by water evaporation can be also used, however, ultrafiltration is more profitable from the view point of energy consumption.

An ultrafiltration membrane used for concentration of silica at ultrafiltration process is illustrated as follows. Separation where the ultrafiltration membrane is applied is for particles of from 1 nm to several microns, and since dissolved polymer is an object of filtration too, filtration accuracy in nano meter region is expressed by fractionation molecular weight. In the present invention, ultrafiltration membrane smaller than 15000 fractionation molecular weight can be desirably used. More desirably, ultrafiltration membrane of 3000-15000 fractionation molecular weight is used. When fractionation molecular weight of membrane is smaller than 3000, resistance to filtration becomes too high and time requirement for filtration becomes too long, therefore, is not profitable from economical view point. And, when fractionation molecular weight of membrane excesses 15000, degree of purification is deteriorated. Polysulfone, polyacrylonitrile, sintered metal, ceramics or carbon can be mentioned as a material of membrane and any kind of membranes can be used, however, from the view point of heat resistance and filtration rate, membrane made of polysulfone can be preferably used. As a shape of membrane, spiral shape, tubular shape or hollow yarn shape can be mentioned and any kinds of shape can be used, especially, membrane of hollow yarn shape is compact and easily to use. Furthermore, in a case when ultrafiltration process unites washing and removing process of excess nitrogen containing alkaline compound, add pure water after it reached to aimed concentration in case of necessity and continue washing to improve removal rate. In this process, it is desirable to concentrate so as the concentration of silica to become 10-50 weight percent.

Further, before or after the ultrafiltration process, a purification process by ion exchange resin can be added in case of necessity. For example, not fixed nitrogen containing alkaline compound can be removed by contacting with H type strong acidic cation exchange resin, and can be purified more by deionization and purification by contacting with OH type strong basic anion exchange resin.

As mentioned above, a colloidal silica containing a nitrogen containing alkaline compound, comprising silica particles inside of which and/or on the surface of which a nitrogen containing alkaline compound is contained can be obtained. The colloidal silica, which is characterized that the alkali metal content per silica is 50 ppm or less, forming nonspherical particles cluster whose ratio of long axis/short axis of these colloidal silica is in the range from 1.1 to 15 and being silica content is from 10 to 50 weight percent, can be obtained.

### EXAMPLES

The present invention will be illustrated more in details according to Examples. Measurements in Examples are carried out by following equipments.
(1) TEM observation: Transmission Electron Microscope H-7500 of Hitachi Ltd., is used.
(2) Specific surface area by BET method: Flow Sorb 2300 of Shimadzu Corporation is used.
(3) Analysis of nitrogen containing alkaline compound except hydrazine: Total organic carbon meter TOC-5000A, SSM-5000A of Shimadzu Corporation is used. Carbon amount is converted into nitrogen containing alkaline compound. Specifically, total organic carbon amount (TOC) is calculated by numerical formula of TOC=TC−IC after total carbon amount (TC) and inorganic carbon amount (IC) are measured. As the standard for TC measurement, glucose aqueous solution of 1 weight percent carbon amount is used, and as the standard for IC measurement, sodium carbonate of 1 weight percent carbon amount is used. Ultrapure water is used as the standard of 0 weight percent carbon amount and using above mentioned standards and calculation curves, 150 μL and 300 μL for TC and 250 μL for IC, are prepared. At TC measurement, 100 mg of specimen is picked and burned in a combustion furnace of 900° C. And at IC measurement, 20 mg of specimen is picked, 10 mL around of (1+1) phosphoric acid are added and reaction is accelerated in a combustion furnace of 200° C.
(4) Analysis of hydrazine: Absorptiometer UV-VISIBLE RECORDING SPECTRO PHOTOMETER UV-160 of Shimadzu Corporation is used. Measurement is carried out according to p-dimethylbenzaldehyde absorption method regulated in JIS B8224. Specifically, specimen is acidized by hydrochloric acid, followed by addition of p-dimethylbenzaldehyde, to obtain yellowish compound. Absorbency of the yellowish compound is measured and hydrazinium ion is quantitated. From the obtained value of hydrazinium ion, concentration of hydrazine is calculated.
(5) Analysis of liquid phase nitrogen containing alkaline compound: Liquid phase is separated from specimen by ultrafiltration, and measured by same method mentioned in (3). Hydrazine is measured by same method to (4).
(6) Calculation of fixed nitrogen containing alkaline compound: Amount of liquid phase nitrogen containing alkaline compound is subtracted from total amount of nitrogen containing alkaline compound, and amount of nitrogen containing alkaline compound is calculated.
(7) Analysis of metal elements: ICP emission spectrometry ULTIMA 2 of Horiba Ltd., is used.

### Example 1

5.2 kg of JIS 3 sodium silicate (SiO₂: 28.8 weight percent, Na₂O: 9.7 weight percent, H₂O: 61.5 weight percent) is added to 28 kg of deionized water, mixed homogeneously and diluted sodium silicate solution of 4.5 weight percent silica concentration is prepared. This diluted sodium silicate is passed through a column containing 20 L of H type strong acidic cation exchange resin (AMBERLITE IR120B, product of ORGANO CORPORATION), which is previously regenerated by hydrochloric acid and dealkalized, then 40 kg of active silicic acid characterized that silica concentration is 3.7 weight percent and pH of 2.9 is obtained. Separately, 10% ethylenediamine aqueous solution is prepared by adding ethylenediamine anhydride to pure water.

As the first, colloidal particles are formed. That is, 16 g of 10% ethylenediamine aqueous solution is added to 500 g of obtained active silicic acid, which is a part of obtained active silicic acid, under constant stirring and adjust pH to 8.5 and maintained 100° C. for 1 hour, then cooled down. The pH of obtained liquid is 10.8 at 25° C., and is confirmed by Transmission Electron Microscope (TEM) observation that the obtained liquid is a colloidal silica, whose short axis is 6 nm and ratio of long axis/short axis is from 1.5 to 15, composed of nonspherical particles cluster. From used amount of active silicic acid and ethylenediamine, molar ratio of silica/ethylenediamine of the colloidal silica is calculated as 28.

Then, colloidal particles are grown up by a build up method. That is, above mentioned colloidal silica is heated again and elevated temperature to 98° C., then 600 g of active silicic acid is added by 8 hours. During adding process of active silicic acid, temperature is maintained at 98° C., and 6 g of 10% ethylenediamine aqueous solution is added in the middle of the process so as to maintain pH between 9 and 10. By evaporation of water during adding process, 560 g of colloidal silica is obtained after cooling. The obtained colloidal silica is characterized that the pH at 25° C. is 9.7, and composed of nonspherical silica particles cluster whose short axis is approximately 10 nm and ratio of long axis/short axis is from 1.5 to 10. And, silica content of the colloidal silica is 6.7%.

After 560 g of said colloidal silica is diluted by adding 600 g of pure water, the colloidal silica is heated again and elevated temperature to 98° C., then 7 kg of active silicic acid is added by 8 hours. During said adding process, pH is maintained at 9-10 by adding 10% ethylenediamine aqueous solution, and the temperature is maintained at 98° C. too. After adding process is over, the liquid is matured for 1 hour at 98° C., then cooled down. Amount of added 10% ethylenediamine aqueous solution is 90 g. 7.46 kg of colloidal silica is obtained and pH of the colloidal silica is 9.7.

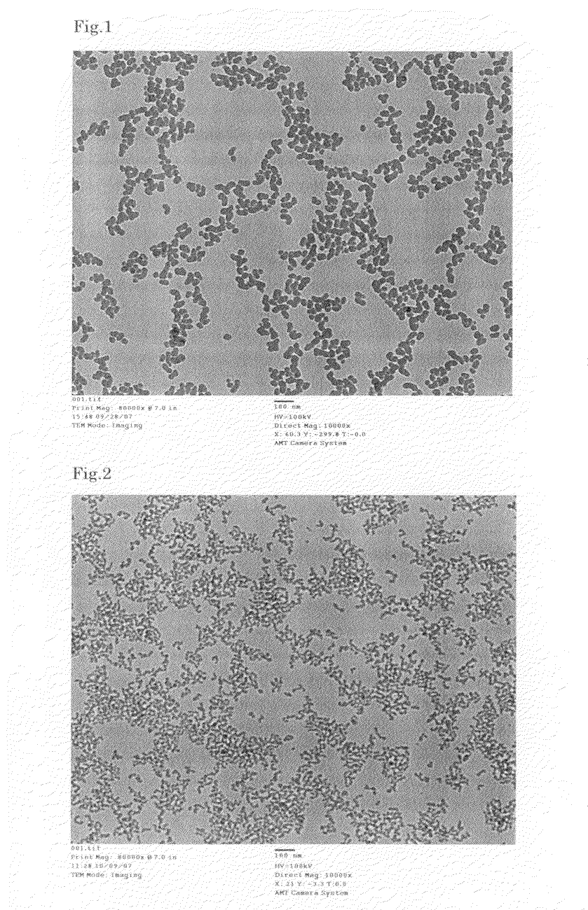

After that, pressure filtration by pump circulation using hollow fiber ultrafilter membrane of 6000 fractionation molecular weight (MICROZA UF MODULE SIP-1013, product of ASAHI Kasei) is carried and concentrated to silica concentration 23 weight percent and approximately 1.35 kg of colloidal silica is recovered. Particle size measured by BET method of this colloidal silica is 18.6 nm, and according to a transmission electron microscope (TEM) observation, short axis is approximately 20 nm and is nonspherical particles cluster, wherein ratio of long axis/short axis is from 1.5 to 7 and average ratio of long axis/short axis is 5. Total content of ethylenediamine is 0.258 weight percent and molar ratio of silica/ethylenediamine is 89. Since liquid phase ethylenediamine is 0.053 weight percent, amount of fixed ethylenediamine is calculated as 0.217 weight percent. It is confirmed that most part of ethylenediamine is fixed to silica. Further, sodium and potassium content per silica are 10 ppm and 0 ppm, respectively. Colloidal silica whose content of alkali metal ion is small can be obtained by use of ethylenediamine. TEM picture of silica particles is shown in FIG. 1.

### Example 2

By same method to Example 1, 40 kg of active silicic acid whose silica content is 3.7 weight percent and pH of 2.9 is obtained.

Separately, 34 g of diethylenediamine 6 hydrate (reagent) is added to pure water and adjust total amount to 190 g, and 8% diethylenediamine aqueous solution is prepared.

30 g of 8% diethylenediamine aqueous solution is added to 500 g active silicic acid by stirring and adjust pH to 8.5, heated and elevate temperature to 100° C. and this temperature is maintained for 1 hour, then 2000 g of active silicic acid is added by 4 hours. At the adding process, 8% diethylenediamine aqueous solution is added so as to maintain pH to 9-10 and also maintain temperature at 100° C. After adding process is over, the liquid is matured for 1 hour at 95° C., then cooled down. Amount of added 8% diethylenediamine aqueous solution is 92 g. 2.39 kg of colloidal silica is obtained and pH of the colloidal silica is 9.98.

After that, pressure filtration by pump circulation using hollow fiber ultrafilter membrane of 6,000 fractionation molecular weight (MICROZA UF MODULE SIP-1013, product of ASAHI Kasei) is carried and concentrated to silica concentration 17.5 weight percent and approximately 504 g of colloidal silica is recovered. Particle size measured by BET method of this colloidal silica is 11.3 nm, and according to a transmission electron microscope (TEM) observation, short axis is approximately 12 nm and is nonspherical particles cluster, wherein ratio of long axis/short axis is from 1.5 to 7 and average ratio of long axis/short axis is 3.5. Total content of diethylenediamine is 1.04 weight percent and molar ratio of silica/diethylenediamine is 24. Since liquid phase diethylenediamine is 0.12 weight percent, amount of fixed diethylenediamine is calculated as 0.94 weight percent. It is confirmed that most part of diethylenediamine is fixed to silica. Further, sodium and potassium content per silica are 15 ppm and 0 ppm, respectively. Colloidal silica whose content of alkali metal ion is small can be obtained by use of diethylenediamine. TEM picture of silica particles is shown in FIG. 2.

### Example 3

By same method to Example 1, 40 kg of active silicic acid whose silica content is 3.7 weight percent and pH of 2.9 is obtained.

Separately, 34 g of diethylenediamine 6 hydrate (reagent) is added to pure water and adjust total amount to 190 g, and 8% diethylenediamine aqueous solution is prepared.

30 g of 8% diethylenediamine aqueous solution is added to 500 g active silicic acid by stirring and adjust pH to 8.5, heated and elevate temperature to 100° C. and this temperature is maintained for 1 hour, then 9500 g of active silicic acid is added by 9 hours. At the adding process, 8% diethylenediamine aqueous solution is added so as to maintain pH to 9-10 and also temperature is maintained to 99° C. After adding process is over, the liquid is matured for 1 hour at 99° C., then cooled down. Amount of added 8% diethylenediamine aqueous solution is 152 g. 8.38 kg of colloidal silica is obtained and pH of the colloidal silica is 9.35.

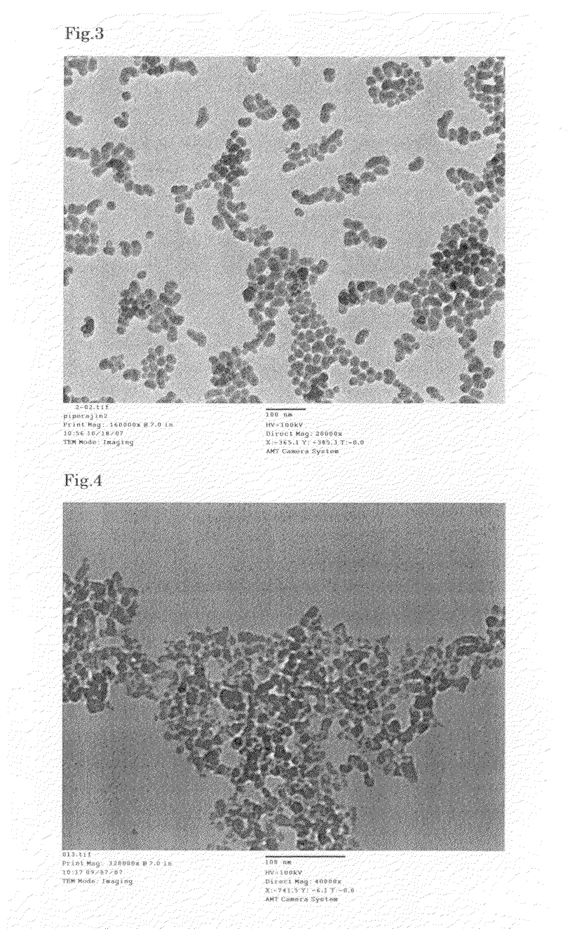

After that, pressure filtration by pump circulation using hollow fiber ultrafilter membrane of 6,000 fractionation molecular weight (MICROZA UF MODULE SIP-1013, product of ASAHI Kasei) is carried and concentrated to silica concentration 29.0 weight percent and approximately 1218 g of colloidal silica is recovered. Particle size measured by BET method of this colloidal silica is 24.6 nm, and according to a transmission electron microscope (TEM) observation, short axis is approximately 25 nm and is nonspherical particles cluster, wherein ratio of long axis/short axis is from 1.5 to 7 and average ratio of long axis/short axis is 3. Total content of diethylenediamine is 0.86 weight percent and molar ratio of silica/diethylenediamine is 48. Since liquid phase diethylenediamine is 0.12 weight percent, amount of fixed diethylenediamine is calculated as 0.77 weight percent. It is confirmed that most part of diethylenediamine is fixed to silica. Further, sodium and potassium content per silica are 8 ppm and 0 ppm, respectively. Colloidal silica whose content of alkali metal ion is small can be obtained by use of diethylenediamine. TEM picture of silica particles is shown in FIG. 3.

### Example 4

In advance, tetramethylammonium hydroxide aqueous solution whose pH is 10.5 is prepared, by adding 2 g of 25% tetramethylammonium hydroxide aqueous solution to 10 kg of pure water. 1000 g of said tetramethylammonium hydroxide aqueous solution whose pH is 10.8 is added to 1000 g of approximately 1218 g of colloidal silica whose silica concentration is 29.0 weight percent obtained in Example 3 so that to dilute. Then concentration by same ultrafiltration as in Example 3 is carried out and adjust silica concentration to 29.0 weight percent. Above mentioned dilution and concentration cycle is repeated 10 times and diethylenediamine is removed. From colloidal silica obtained as final, diethylenediamine is not detected. Total content of diethylenediamine in obtained colloidal silica is 0.65 weight percent and molar ratio of silica/diethylenediamine of it is 64. Accordingly, amount of diethylenediamine is reduced from 0.77 weight percent to 0.65 weight percent, and consequently, diethylenediamine fixed to the surface of silica particles is washed out by tetramethylammonium hydroxide aqueous solution.

### Example 5

By same method to Example 1, 8080 g of active silicic acid whose silica content is 3.7 weight percent and pH of 2.9 is obtained. Separately, imidazole crystal (99% reagent) is dissolved in pure water and 10% imidazole aqueous solution and 2.5% imidazole aqueous solution are prepared.

Then, colloidal particles are grown up by a build up method. That is, to 1000 g of said obtained active silicic acid, which is a part of obtained active silicic acid, 10% imidazole aqueous solution is added by stirring and pH is adjusted to 8.0, heated to 95° C. and preserved for 1 hour, then remaining 7080 g of active silicic acid is added by 4.2 hours. During adding process, 2.5% imidazole aqueous solution is added so as to maintain pH to 8.0-8.5 and also temperature is maintained at 97° C. After adding process is over, matured at 97° C. for 1 hour, then is cooled down. Calculated from used amount of active silicic acid and imidazole, molar ration of silica/imidazole is 11. After that, pressure filtration by pump circulation using hollow fiber ultrafilter membrane of 6,000 fractionation molecular weight (MICROZA UF MODULE SIP-1013, product of ASAHI Kasei) is carried and concentrated to silica concentration of 21 weight percent and approximately 1300 g of colloidal silica is recovered. Particle size measured by BET method of this colloidal silica is 10 nm, and according to a transmission electron microscope (TEM) observation, it is understood that the colloidal silica forms nonspherical particles cluster, wherein short axis is approximately 12 nm and ratio of long axis/short axis is from 1.5 to 10. Average ratio of long axis/short axis is approximately 3. Total amount of imidazole content is 0.85 weight percent and molar ratio of silica/imidazole is 28. Imidazole fixed to silica is 0.77 weight percent, since liquid phase imidazole is 0.10 weight percent, imidazole fixed to silica is 0.77 weight percent. It can be confirmed that most of imidazole is fixed to silica. Further, sodium and potassium content per silica are respectively 1 ppm and 0 ppm. Colloidal silica whose content of alkali metal ion is small can be obtained by use of imidazole. TEM picture of silica particles is shown in FIG. 4.

### Example 6

By same method to Example 1, 5500 g of active silicic acid whose silica content is 3.7 weight percent and pH of 2.9 is obtained. Separately, 2-methylimidazole crystal (99% reagent) is dissolved in pure water and 10% methylimidazole aqueous solution and 3% methylimidazole aqueous solution are prepared.

Then, colloidal particles are grown up by a build up method. That is, to 1000 g of said obtained active silicic acid, which is a part of obtained active silicic acid, 10% methylimidazole aqueous solution is added by stirring and pH is adjusted to 8.0, heated to 95° C. and preserved for 1 hour, then remaining 4500 g of active silicic acid is added by 3.8 hours. During adding process, 3% methylimidazole aqueous solution is added so as to maintain pH to 9.0 and also temperature is maintained at 97° C. After adding process is over, matured at 97° C. for 1 hour, then is cooled down. Calculated from used amount of active silicic acid and methylimidazole, molar ratio of silica/methylimidazole is 15. After that, pressure filtration by pump circulation using hollow fiber ultrafilter membrane of 6,000 fractionation molecular weight (MICROZA UF MODULE SIP-1013, product of ASAHI Kasei) is carried and concentrated to silica concentration 22 weight percent and approximately 900 g of colloidal silica is recovered. Particle size measured by BET method of this colloidal silica is 11.5 nm, and according to a transmission electron microscope (TEM) observation, it is understood that the colloidal silica forms nonspherical particles cluster, wherein short axis is approximately 12 nm and ratio of long axis/short axis is approximately from 1.5 to 15. Average ratio of long axis/short axis is approximately 5. Total amount of methylimidazole content is 0.76 weight percent and molar ratio of silica/methylimidazole is 40. Since liquid phase methylimidazole is 0.30 weight percent, methylimidazole fixed to silica is 0.53 weight percent. It can be confirmed that most of methylimidazole is fixed to silica. Further, sodium and potassium content per silica are 2 ppm and 0 ppm, respectively. Colloidal silica whose content of alkali metal ion is small can be obtained by use of methylimidazole. TEM picture of silica particles is shown in FIG. 5.

### Example 7

By same method to Example 1, 5000 g of active silicic acid whose silica content is 3.7 weight percent and pH of 2.9 is obtained. Separately, 10% piperidine aqueous solution is prepared by adding piperidine (reagent) to pure water.

First, colloidal particles are formed. That is, 20 g of 10% piperidine aqueous solution is added to 500 g of said obtained active silicic acid, which is a part of obtained active silicic acid, by stirring and pH is adjusted to 8.5 while temperature is maintained at 100° C. for 1 hour, then cooled down. Amount of the obtained liquid becomes 460 g by evaporation of water, and concentration of silica is 4.0 weight percent. And pH at 25° C. of obtained liquid is 9.7, and is confirmed by Transmission Electron Microscope (TEM) observation that the obtained liquid is a colloidal silica composed of nonspherical silica particles cluster, whose short axis is 6 nm and ratio of long axis/short axis is from 1.5 to 15. Average ratio of long axis/short axis is 6.

From used amount of active silicic acid and piperidine, molar ratio of silica/piperidine of the colloidal silica is calculated as 28. Since liquid phase piperidine is 0.23 weight percent, piperidine fixed to silica is calculated as 0.22 weight percent. It can be confirmed that piperidine is fixed to silica.

### Example 8

Colloidal silica obtained in Example 7 is heated again and temperature is elevated to 100° C., and 2500 g of active silicic acid is added by 4 hours. During adding process of active silicic acid, temperature is maintained to 100° C., and 10% piperidine aqueous solution is added simultaneously and pH is maintained at 9-10. Amount of simultaneously added 10% piperidine is 68 g. By evaporation of water during adding process, 2660 g of colloidal silica is obtained after cooling. The pH of said obtained colloidal silica at 25° C. is 9.58, and by Transmission Electron Microscope (TEM) observation, it is confirmed that the colloidal silica is composed of nonspherical silica particles cluster whose short axis is approximately 12 nm and ratio of long axis/short axis is from 1.5 to 10.

Then, pressure filtration by pump circulation using hollow fiber ultrafilter membrane of 6,000 fractionation molecular weight (MICROZA UF MODULE SIP-1013, product of ASAHI Kasei) is carried and concentrated to silica concentration 18 weight percent and approximately 550 g of colloidal silica is recovered. The pH of said obtained colloidal silica at 25° C. is 9.14, and by Transmission Electron Microscope (TEM) observation, it is confirmed that the colloidal silica forms nonspherical particles cluster, wherein short axis is approximately 12 nm and ratio of long axis/short axis is approximately from 1.5 to 15, and average ratio of long axis/short axis is 3.5. Further, particle size by BET method is 11.3 nm.

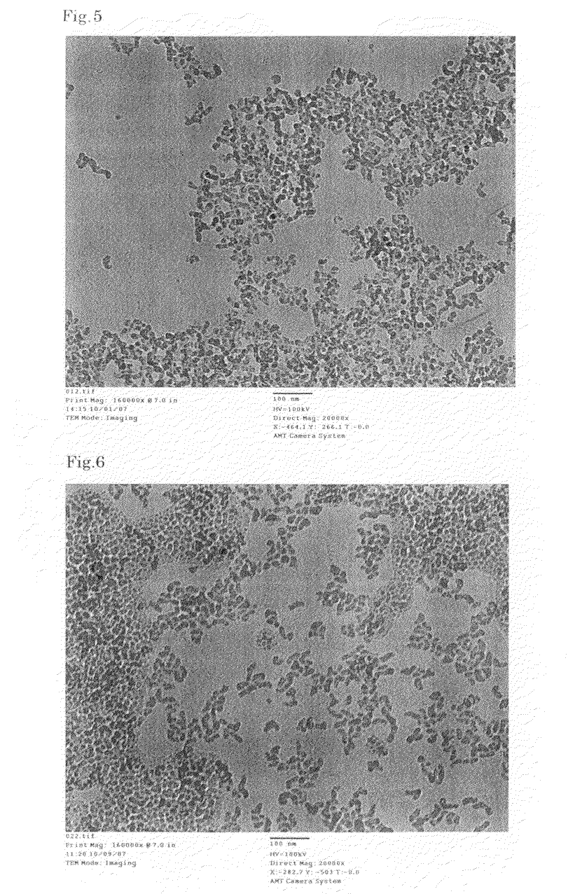

Total amount of piperidine content is 0.96 weight percent and molar ratio of silica/piperidine is 27. Since liquid phase piperidine is 0.25 weight percent, piperidine fixed to silica is calculated as 0.76 weight percent. It can be confirmed that piperidine is fixed to silica. Further, sodium and potassium content per silica are 15 ppm and 0 ppm, respectively. Colloidal silica whose content of alkali metal ion is small can be obtained by use of piperidine. TEM picture of silica particles is shown in FIG. 6.

### Example 9

By same method to Example 1, 5000 g of active silicic acid whose silica content is 3.7 weight percent and pH of 2.9 is obtained.

Separately, 10% morpholine aqueous solution is prepared by adding morpholine (reagent) to pure water.

Then, colloidal particles are formed. That is, 70 g of 10% morpholine aqueous solution is added to 500 g of said obtained active silicic acid, which is a part of obtained active silicic acid, by stirring and pH is adjusted to 9.0 and while temperature is maintained at 100° C. for 1 hour, then cooled down. Amount of the obtained liquid becomes 460 g by evaporation of water, and concentration of silica is 4.0 weight percent. And pH at 25° C. of obtained liquid is 9.8, and is confirmed by Transmission Electron Microscope (TEM) observation that the obtained liquid is a colloidal silica composed of nonspherical silica particles cluster, whose short axis is 6 nm and ratio of long axis/short axis is from 1.5 to 10. Average ratio of long axis/short axis is 3.

From used amount of active silicic acid and morpholine, molar ratio of silica/morpholine of the colloidal silica is calculated as 3.9. Total morpholine concentration of the colloidal silica is 1.52 weight percent. Since liquid phase morpholine is 0.72 weight percent, morpholine fixed to silica is calculated as 0.83 weight percent. It can be confirmed that morpholine is fixed to silica.

### Example 10

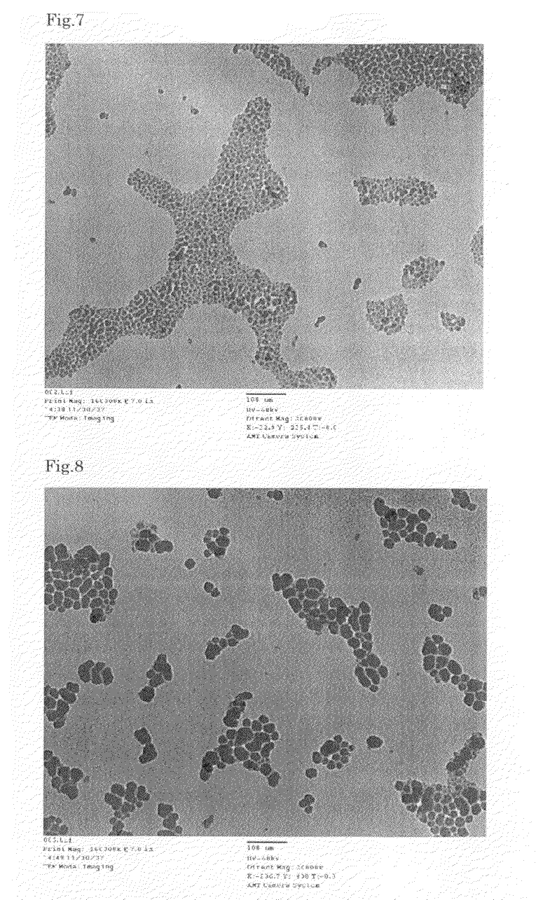

Colloidal silica obtained in Example 9 is heated again and temperature is elevated to 100° C., and 1000 g of active silicic acid is added by 4 hours. During adding process of active silicic acid, temperature is maintained at 100° C., and 10% morpholine aqueous solution is added simultaneously and pH is maintained at 9-10. Amount of simultaneously added morpholine aqueous solution is 30 g. By evaporation of water during adding process, 870 g of colloidal silica is obtained after cooling. Concentration of silica of said obtained colloidal silica is 6.4 weight percent. The pH of the colloidal silica at 25° C. is 9.7, and by Transmission Electron Microscope (TEM) observation, it is confirmed that the colloidal silica is composed of nonspherical silica particles cluster whose short axis is approximately 8 nm and ratio of long axis/short axis is 1.5-6. Average ratio of long axis/short axis is 2.5. TEM picture is shown in FIG. 7.

From used amount of active silicic acid and morpholine, molar ratio of silica/morpholine of the colloidal silica is calculated as 8.0. Total morpholine concentration of the colloidal silica is 1.15 weight percent. Since liquid phase morpholine is 0.74 weight percent, morpholine fixed to silica is calculated as 0.46 weight percent. It can be confirmed that morpholine is fixed to silica.

### Example 11

230 g of colloidal silica, a part of obtained colloidal silica in Example 10, is picked up, and is heated again while temperature is elevated to 100° C., and 2000 g of active silicic acid is added by 5 hours. During adding process of active silicic acid, temperature is maintained at 100° C., and 10% morpholine aqueous solution is added simultaneously and pH is maintained at 9-10. Amount of simultaneously added 10% morpholine aqueous solution is 90 g. By evaporation of water during adding process, 1360 g of colloidal silica is obtained after cooling. Concentration of silica of said obtained colloidal silica is 6.5 weight percent. The pH of the colloidal silica at 25° C. is 9.4, and by Transmission Electron Microscope (TEM) observation, it is confirmed that the colloidal silica is composed of nonspherical silica particles cluster whose short axis is approximately 15 nm and ratio of long axis/short axis is from 1.5 to 4.

From used amount of active silicic acid and morpholine, molar ratio of silica/morpholine of the colloidal silica is calculated as 11.0. Total morpholine concentration of the colloidal silica is 0.86 weight percent. Since liquid phase morpholine is 0.41 weight percent, morpholine fixed to silica is calculated as 0.48 weight percent. It can be confirmed that morpholine is fixed to silica.

Then, pressure filtration by pump circulation using hollow fiber ultrafilter membrane of 6,000 fractionation molecular weight (MICROZA UF MODULE SIP-1013, product of ASAHI Kasei) is carried and concentrated to silica concentration 17 weight percent and approximately 586 g of colloidal silica is recovered. The pH of said obtained colloidal silica at 25° C. is 9.2, and by Transmission Electron Microscope (TEM) observation, it is confirmed that the colloidal silica forms nonspherical particles cluster, wherein short axis is approximately 15 nm and ratio of long axis/short axis is approximately from 1.5 to 4. Average ratio of long axis/short axis is 2. And particle size by BET method is 14.1 nm.

Total amount of morpholine content is 0.81 weight percent and molar ratio of silica/morpholine is 30. Since liquid phase morpholine is 0.74 weight percent, morpholine fixed to silica is calculated as 0.20 weight percent. It can be confirmed that morpholine is fixed to silica. Further, sodium and potassium content per silica are 15 ppm and 0 ppm, respectively. Colloidal silica whose content of alkali metal ion is small can be obtained by use of morpholine. TEM picture of silica particles is shown in FIG. 8.

### Example 12

By same method to Example 1, 40 kg of active silicic acid whose silica content is 3.7 weight percent and pH is 2.9 of obtained.

Separately, 10% arginine aqueous solution is prepared by adding arginine (reagent) to pure water.

Then, colloidal particles are formed. That is, 50 g of 10% arginine aqueous solution is added to 500 g of said obtained active silicic acid, which is a part of obtained active silicic acid, by stirring and pH is adjusted to 8.5 while temperature is maintained at 100° C. for 1 hour, then cooled down. Amount of the obtained liquid becomes 460 g by evaporation of water, and pH at 25° C. of obtained liquid is 9.2, and is confirmed by Transmission Electron Microscope (TEM) observation that the obtained liquid is a colloidal silica composed of nonspherical silica particles cluster, whose short axis is 6 nm and ratio of long axis/short axis is from 1.5 to 15. From used amount of active silicic acid and arginine, molar ratio of silica/arginine of the colloidal silica is calculated as 11.

Total arginine concentration of the colloidal silica is 1.1 weight percent. Since liquid phase arginine is 0.28 weight percent, arginine fixed to silica is calculated as 0.83 weight percent. It can be confirmed that arginine is fixed to silica. Further, sodium and potassium content per silica are 10 ppm and 0 ppm, respectively. Colloidal silica whose content of alkali metal ion is small can be obtained by use of arginine. TEM picture of silica particles is shown in FIG. 9.

### Example 13

Colloidal silica obtained in Example 12 is heated again and temperature is elevated to 100° C., and 9500 g of active silicic acid is added by 4 hours. During adding process of active silicic acid, temperature is maintained to 100° C., and 10% arginine aqueous solution is added simultaneously while pH is maintained 9-10. Amount of simultaneously added 10% arginine aqueous solution is 112 g. By evaporation of water during adding process, 7360 g of colloidal silica is obtained after cooling. The pH of the colloidal silica at 25° C. is 9.09.

Then, pressure filtration by pump circulation using hollow fiber ultrafilter membrane of 6,000 fractionation molecular weight (MICROZA UF MODULE SIP-1013, product of ASAHI Kasei) is carried and concentrated to silica concentration 25 weight percent and approximately 1470 g of colloidal silica is recovered. The pH of said obtained colloidal silica at 25° C. is 8.60, and by Transmission Electron Microscope (TEM) observation, it is confirmed that the colloidal silica forms distorted spherical or long and slender silica particles cluster, wherein average ratio of long axis/short axis is 1.3. Further, particle size by BET method is 11.2 nm.

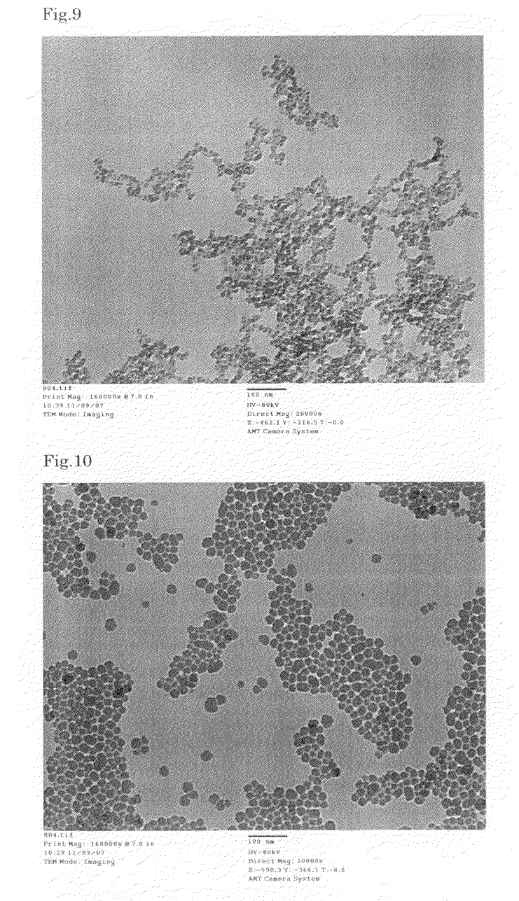

Total amount of arginine content is 0.63 weight percent and molar ratio of silica/arginine is 115. Since liquid phase arginine is 0.11 weight percent, arginine fixed to silica is calculated as 0.55 weight percent. It can be confirmed that arginine is fixed to silica. Further, sodium and potassium content per silica are 10 ppm and 0 ppm, respectively. Colloidal silica whose content of alkali metal ion is small can be obtained by use of arginine. TEM picture of silica particles is shown in FIG. 10.

### Example 14

By same method to Example 1, 2.7 kg of active silicic acid whose silica content is 3.7 weight percent and pH is 2.9 of obtained.

Separately, 5.1% hydrazine aqueous solution is prepared by adding hydrazine (hydrazine hydrate, N₂H₄.H₂O; reagent) to pure water.

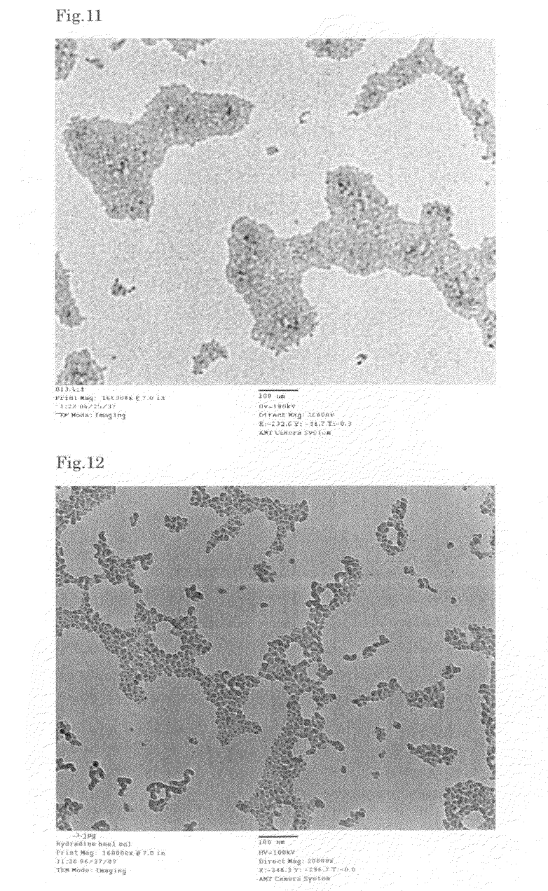

Then, colloidal particles are formed. That is, 24 g of 1% hydrazine aqueous solution is added to 800 g of said obtained active silicic acid, which is a part of obtained active silicic acid, by stirring and pH is adjusted to 8.2 and temperature is maintained 100° C. for 1 hour, then cooled down. The pH of obtained liquid is 8.7, and 5.1% hydrazine solution is added and pH is adjusted to 9.2. Silica content of the obtained solution is 3.5 weight percent. BET particle size is 6.0 nm. By Transmission Electron Microscope (TEM) observation, the obtained liquid is a colloidal silica composed of nonspherical silica particles cluster, whose short axis is 6 nm and ratio of long axis/short axis is from 1.5 to 15. Average ratio of long axis/short axis is 6. TEM picture of silica particles is shown in FIG. 11.

From used amount of active silicic acid and hydrazine, molar ratio of silica/hydrazine of the colloidal silica is calculated as 5.3. Total hydrazine concentration of the colloidal silica is 0.34 weight percent. Hydrazine content of liquid phase on filtrated liquid by pressure filtration is measured as 0.29%. Accordingly, hydrazine fixed to silica particles is calculated as 0.06 weight percent.

### Example 15

By same method to Example 1, 5 kg of active silicic acid whose silica content is 3.7 weight percent and pH of 2.9 is obtained.

Separately, 2.6% hydrazine aqueous solution is prepared by adding hydrazine (hydrazine hydrate, N₂H₄.H₂O; reagent) to pure water.

Colloidal silica obtained in Example 14 is heated again and temperature is elevated to 100° C., and 4.2 kg of active silicic acid is added by 3.8 hours. During adding process of active silicic acid, temperature is maintained to 100° C., and 0.57 kg of 2.6% hydrazine aqueous solution is added simultaneously while pH is maintained at 9-10. The pH of the colloidal silica at 25° C. is 9.2, BET particle size is 12 nm. By Transmission Electron Microscope (TEM) observation, the obtained liquid is a colloidal silica composed of nonspherical silica particles cluster, whose short axis is 12 nm and ratio of long axis/short axis is from 1.5 to 10.

Then, pressure filtration by pump circulation using hollow fiber ultrafilter membrane of 6,000 fractionation molecular weight (MICROZA UF MODULE SIP-1013, product of ASAHI Kasei) is carried and concentrated to silica concentration 18 weight percent and approximately 970 g of colloidal silica is recovered. The pH of said obtained colloidal silica at 25° C. is 8.6, and by Transmission Electron Microscope (TEM) observation, it is confirmed that the colloidal silica forms nonspherical particles cluster, wherein short axis is approximately 12 nm and ratio of long axis/short axis is approximately from 1.5 to 10. Average ratio of long axis/short axis is 3.5.

Total amount of hydrazine content is 0.64 weight percent and molar ratio of silica/hydrazine is 15. Hydrazine content of liquid phase on filtrated liquid is measured as 0.50% by pressure filtration. Accordingly, hydrazine fixed to silica particles is calculated as 0.23 weight percent. Further, sodium and potassium content per silica are 2 ppm and 0 ppm, respectively. Colloidal silica whose content of alkali metal ion is small can be obtained by use of hydrazine. TEM picture of silica particles is shown in FIG. 12.

### Example 16

A part of colloidal silica obtained in Example 15 is picked up, and concentrated to silica concentration 30 weight percent by ultrafiltration. Total amount of hydrazine content of the obtained colloidal silica is 0.73 weight percent and molar ratio of silica/hydrazine of the colloidal silica is 22. Since liquid phase hydrazine is 0.50 weight percent, hydrazine fixed to silica is calculated as 0.38 weight percent.

What is claim:

1. A colloidal silica comprising, silica particles inside of which or on the surface of which a nitrogen containing alkaline compound is fixed, wherein said silica particles are prepared by forming and growing colloid particles using the nitrogen containing alkaline compound.

2. The colloidal silica of claim 1, wherein a nitrogen containing alkaline compound is at least one compound selected from the group consisting of ethylenediamine, diethylenediamine, imidazole, methylimidazole, piperidine, morpholine, arginine, and hydrazine.

3. The colloidal silica of claim 1, wherein molar ratio of silica/nitrogen containing alkaline compound is from 3 to 120.

4. The colloidal silica of claim 1, wherein the colloidal silica contains a nitrogen containing alkaline compound and forms nonspherical particles cluster, ratio of long axis/short axis of silica particles measured by a transmission electric microscope is from 1.1 to 15 and average value of the ratio of long axis/short axis is from 1.2 to 6.

5. The colloidal silica of claim 1, wherein the average length of short axis of the silica particles measured by a transmission electric microscope is from 5 to 30 nm and content of silica is from 10 to 50 weight percent.

6. The colloidal silica of claim 1, wherein content of alkali metal to silica is 50 ppm or less.

7. A method for preparation of the colloidal silica of claim 1 comprising, following processes,
(a) a process to prepare active silicic acid aqueous solution by contacting alkali silicate aqueous solution with cation exchange resin,
(b) a process to add a nitrogen containing alkaline compound to said active silicic acid aqueous solution so as to alkalize the solution and to form colloidal particles by heating,
(c) a process to grow colloidal particles by adding said active silicic acid aqueous solution and the nitrogen containing alkaline compound to the colloidal particles formed in previous process maintaining alkaline state, under heating condition.

8. The method for preparation of the colloidal silica of claim 7, further comprising,
(d) process to concentrate silica after (c) process.
